(19) United States
(12) Patent Application Publication
(10) Pub. No.: US 2015/0144644 A1
(43) Pub. Date: May 28, 2015

(54) PLASTIC DRUMS AND METHODS FOR MANUFACTURING PLASTIC DRUMS

(71) Applicant: Greif Packaging, LLC, Delaware, OH (US)

(72) Inventor: James P. Craig, Galena, OH (US)

(21) Appl. No.: 14/552,996

(22) Filed: Nov. 25, 2014

Related U.S. Application Data
(60) Provisional application No. 61/909,398, filed on Nov. 27, 2013.

(51) Int. Cl. B65D 8/00; B29C 65/14; B29C 45/16; B29C 65/08; B29C 65/48; B29C 45/00; B29C 65/18; B29C 65/06

(52) U.S. Cl. CPC B65D 11/06; B29C 65/18; B29C 65/1412; B29C 65/0672; B29C 65/08; B29C 65/48; B29C 45/0001; B29C 45/1657; B29L 2031/7154
USPC 220/677; 206/524.6; 156/245; 156/82; 156/154

(57) ABSTRACT

Various methods are described for manufacturing a plastic drum that includes injection-molding upper and lower drum body portions having sidewalls that terminate at an open end. The open end of each drum body portion includes a drum body welding platform. The platform is characterized by a thickening of the drum body portion sidewall. The methods also include aligning the upper drum body portion with respect to the lower drum body portion such that the upper drum body welding platform is aligned with the lower drum body welding platform at an interface, and joining the upper drum body portion to the lower drum body portion at the interface to form the plastic drum. Also described are plastic drums made by the noted methods.

### CROSS REFERENCES TO RELATED APPLICATIONS

This application claims priority from U.S. provisional application Ser. No. 61/909,398 filed on Nov. 27, 2013.

### FIELD

The present subject matter relates to methods for manufacturing plastic drums. The present subject matter also relates to plastic drums. More particularly, the present subject matter relates to methods for manufacturing a plastic drum or barrel that includes joining injection-molded upper and lower drum body portions together at a central joining seam.

### BACKGROUND

Most plastic drums that comply with 49 C.F.R. §178.509 (as of Oct. 1, 2012) are manufactured by a blow-molding process that involves clamping a tubular stream of molten thermoplastic between halves of a mold and immediately blowing air into the tubular stream of molten thermoplastic to expand and press the same against the inner walls of the mold cavity. While air pressure holds the thermoplastic in contact with the mold, the mold is cooled causing the thermoplastic in contact therewith to solidify and thereby retain the shape of the mold cavity. The two halves of the mold are then separated, and the blow-molded container is removed. The blow-molded container must then be trimmed, either by hand or using automated equipment, to remove flash from the initial stream of molten plastic both above and below the plastic drum thus formed.

The blow-molding process is complicated. It requires that the molten thermoplastic stream be at a precise temperature and flow rate, and involves high capital-cost equipment. Drums produced by blow-molding are known to have sidewalls of variable thickness due to the manufacturing process, and may also have inner surfaces that have embedded particulates that are blown into the drum during the manufacturing process. Furthermore, because the drums are removed from the mold cavity soon after they are formed, the “roundness” of the drum can be compromised, resulting in a slightly ovular shape in cross-section.

Recently, the assignee of the present application developed a plastic drum that is an alternative to blow-molded drums and which is presently being marketed under the NexDRUM® brand. Such drums are formed by injection molding a disk-like drum top and a disk-like drum bottom, each of which include a short skirt. The short skirts of the drum top and drum bottom are separately joined to a tubular central body, which is formed by extrusion thermoforming and cut to the desired length. The cut edges of the extruded tubular central body are aligned with the edge of the short skirts of the top and bottom, respectively, and are joined by welding. NexDRUM® brand plastic drums offer substantial advantages over blow-molded plastic drums. Although satisfactory in many respects, a need exists for an improved method of manufacturing plastic drums, and improved plastic drums.

### SUMMARY

In one aspect, the present subject matter provides a method for manufacturing a plastic drum that comprises injection-molding an upper drum body portion having a sidewall that terminates at an open end in an upper drum body welding platform. The upper drum body welding platform is characterized by a thickening of the upper drum body portion sidewall. The method also comprises injection-molding a lower drum body portion having a sidewall that terminates at an open end in a lower drum body welding platform. The lower drum body welding platform is characterized by a thickening of the lower drum body portion sidewall. The method additionally comprises aligning the upper drum body portion with respect to the lower drum body portion such that the upper drum body welding platform is aligned with the lower drum body welding platform at an interface. And, the method also comprises joining the upper drum body portion to the lower drum body portion at the interface to form the plastic drum.

In another aspect, the present subject matter provides a plastic drum made by the foregoing method.

In yet another aspect, the present subject matter provides a plastic drum comprising an upper drum body portion including a circular top face defining an outer periphery, and a continuous first sidewall extending from the outer periphery of the top face to thereby define a first open end. The first sidewall has a region of increased thickness adjacent the first open end. The plastic drum also comprises a lower drum body portion including a circular bottom face defining an outer periphery, and a continuous second sidewall extending from the outer periphery of the bottom face to thereby define a second open end, The second sidewall has a region of increased thickness adjacent the second open end. The first open end contacts and sealingly engages the second open end along a single central joining seam.

The methods and drums according to the present subject matter provide many of the same advantages over blow-molded drums that are provided by the drums presently marketed under the NexDRUM® brand, but do so with half as many welds per drum and without the need for an extrusion line to form tubular drum bodies. Drums formed in accordance with the noted methods have a tighter tolerance in terms of the gauge of the body sidewall as compared to the prior art (both extruded sidewalls and blow-molded sidewalls).

The foregoing and other features of the subject matter are hereinafter more Bally described and particularly pointed out in the claims, the following description setting forth in detail certain illustrative embodiments of the subject matter, these being indicative, however, of but a few of the various ways in which the principles of the present subject matter may be employed.

### BRIEF DESCRIPTION OF THE DRAWINGS

FIG. 1 is a perspective view of an exemplary plastic drum according to the present subject matter.

FIG. 2 is a side view of the drum shown in FIG. 1.

FIG. 3 is an enlarged view of a portion of the exemplary plastic drum shown in FIG. 2.

FIG. 4 is a top view of an exemplary upper drum body portion according to the present subject matter.

FIG. 5 is a side section view of the upper drum body portion shown in FIG. 4 taken along the line A-A in FIG. 4.

FIG. 6 is an enlarged view of a portion of the section view shown in FIG. 5.

FIG. 7 is a bottom view of an exemplary lower drum body portion according to the present subject matter.

FIG. 8 is a side section view of the lower drum body portion shown in FIG. 7 taken along the line A-A in FIG. 7.

FIG. 9 is an enlarged view of a portion of the section view shown in FIG. 8.

FIG. 10 is a schematic view of a process for joining an upper drum body portion and a lower drum body portion together to form a plastic drum according to the present subject matter.

FIG. 11 is a schematic representation of an exemplary welding platform of an upper drum body portion aligned with an exemplary welding platform of a lower drum body portion in accordance with the present subject matter.

### DETAILED DESCRIPTION OF THE EMBODIMENTS

The present subject matter provides various polymeric or plastic drums that can be formed by injection molding of an upper drum body portion and a lower drum body portion. Each drum body portion includes a relatively thick sidewall region extending along an open end of the drum body portion. This relatively thick sidewall region is referred to herein as “a welding platform.” The upper and lower drum body portions are joined to one another by aligning the drum body portions and contacting or otherwise engaging their respective open ends together. A variety of sealing techniques can be used to sealingly engage the upper and lower drum body portions together. These and other aspects are described herein as follows.

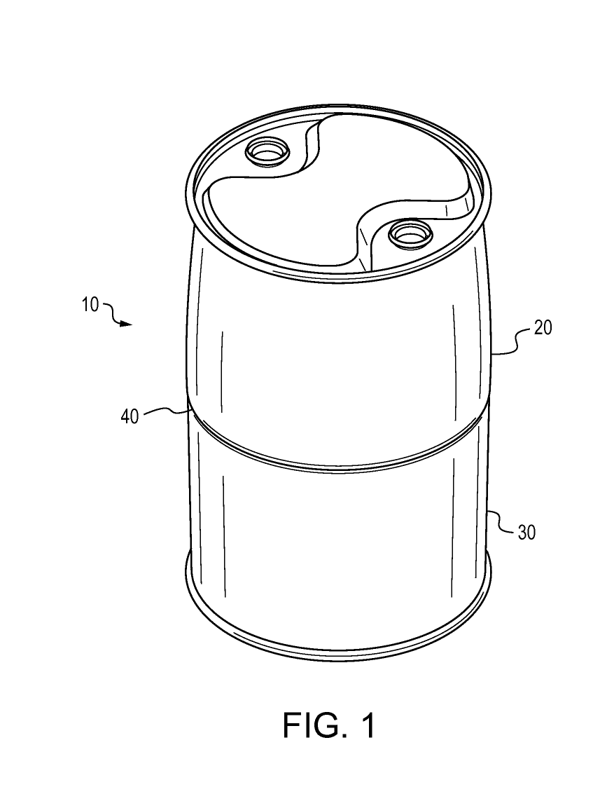

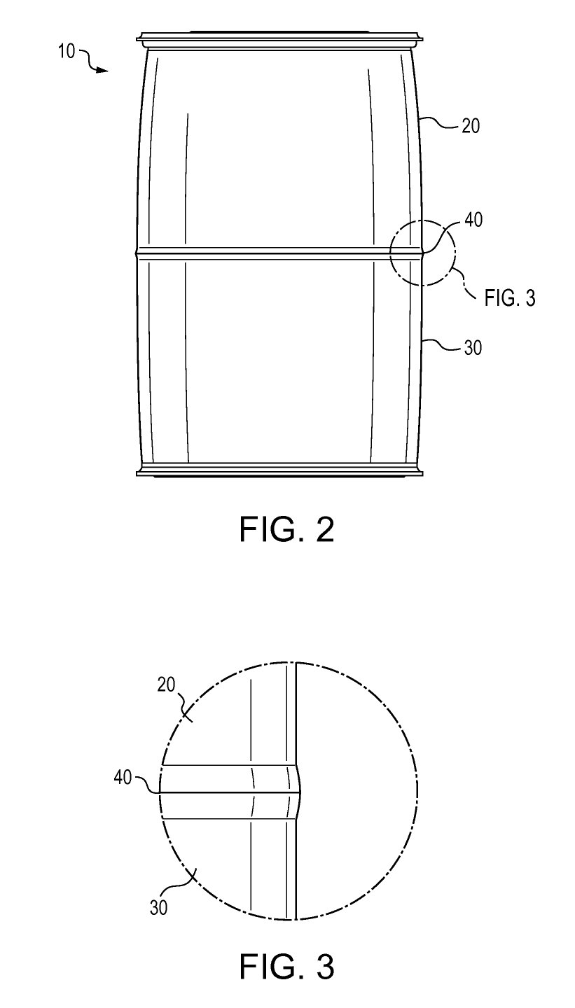

FIGS. 1 and 2 show a perspective view and side view, respectively, of an exemplary plastic drum 10 according to the present subject matter. In very general terms the plastic drum 10 comprises a plastic injection-molded upper drum body portion 20 that has been joined to a plastic injection-molded lower drum body portion 30 at a central joining seam 40. FIG. 3 shows an enlarged view of the central joining seam. In many embodiments of the present subject matter, the upper and lower drum body portions are joined to each other along a single central joining seam. That is, the only seam along the sidewall(s) of the drum is the single, circular seam extending around the circumference of the drum sidewall and located at about a midpoint of the height of the drum.

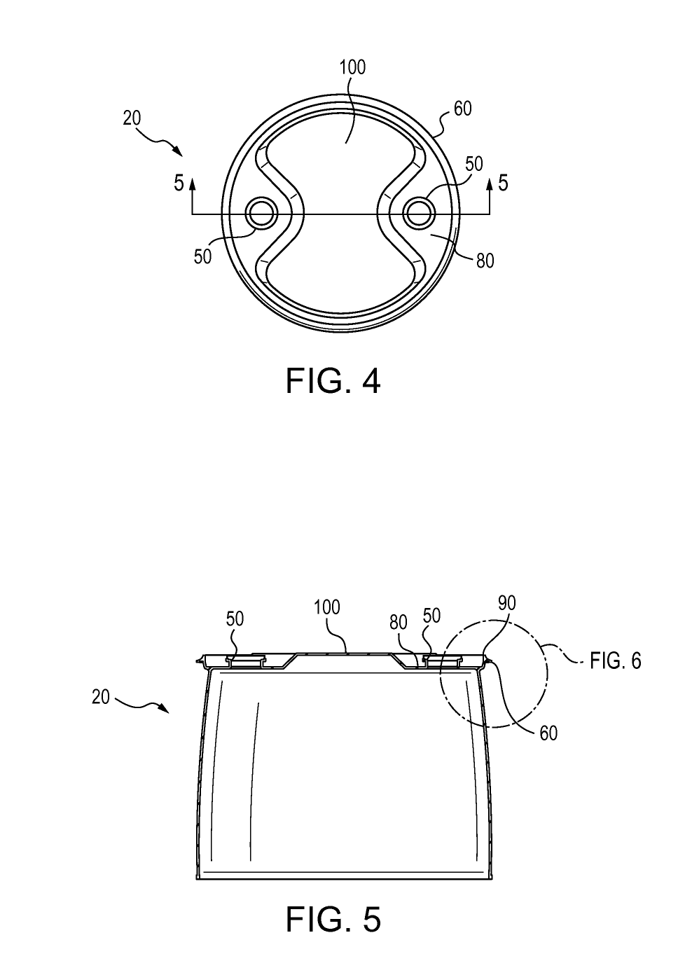

FIG. 4 shows a top view of the upper drum body portion 20 of the drum shown in FIGS. 1 and 2. In this embodiment, a non-removable head (also known as “closed head” plastic drum (1H1) is shown. It will be appreciated that removable head (also known as “open head”) plastic drums (1H2) can also be formed in accordance with the method. In the illustrated embodiment, the non-removable plastic head drum includes two internally threaded openings for receiving closures. Container closures can include bungs or threaded plugs for closed head versions. Separately, lids with various securing methods, such as lock bands, straps or threaded systems, can be used for open head versions.

Generally, the upper drum body portion 20 includes a circular top face 80 which defines an outer circumferential periphery, and a continuous sidewall that extends generally transversely from the top face to an open end. In many embodiments, the sidewall has a region of increased thickness adjacent to the open end of the upper drum body portion 20. The lower drum body portion 30 includes a circular bottom face 110 which defines an outer circumferential periphery, and a continuous sidewall that extends generally transversely from the bottom face to an open end. In many embodiments, the sidewall of the lower drum body portion has a region of increased thickness adjacent to the open end of the lower drum body portion 30.

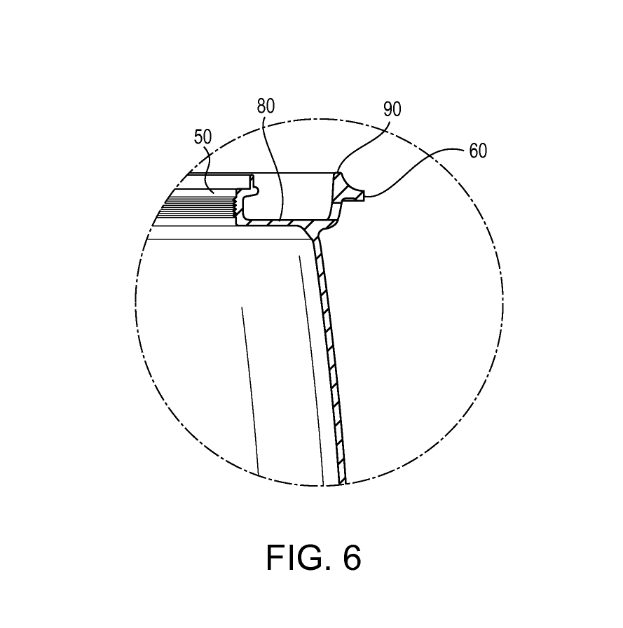

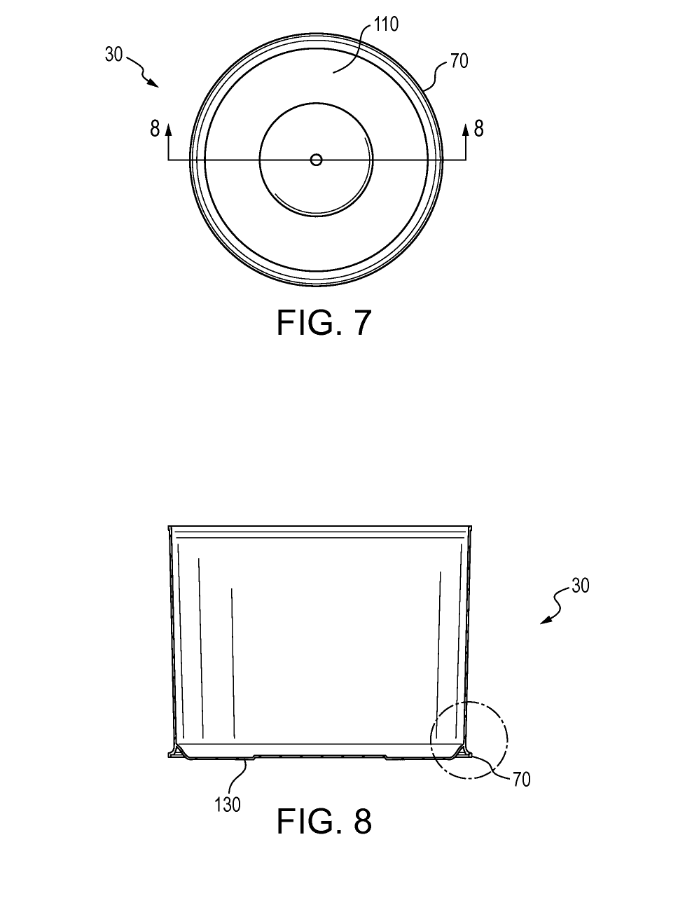

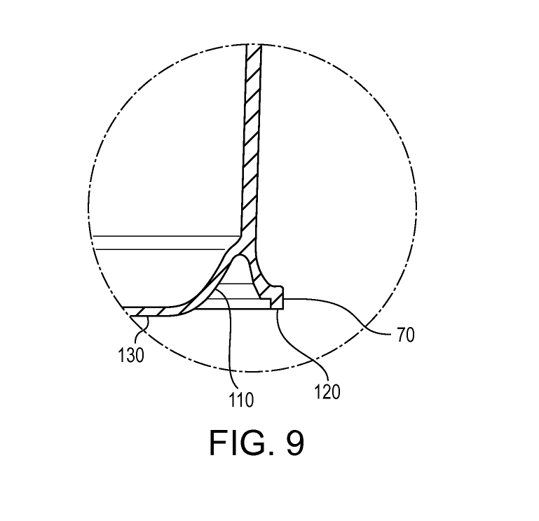

As best illustrated in FIGS. 5 and 6, in certain embodiments the upper drum body portion 20 includes a radially extending chime 60, which facilitates handling of the drum by hand when empty, or by various conventional drum handling equipment and methods when filled. Similarly, FIG. 7 shows a bottom view of the lower drum body portion 30 of the drum shown in FIGS. 1 and 2. As best illustrated in FIGS. 8 and 9, in certain embodiments the lower drum body portion 30 also includes a radially extending chime 70, which facilitates handling of the drum by hand when empty, or by various conventional drum handling equipment and methods when filled. The chimes 60, 70 also assist in load support and distribution when drums are stacked using pallets or other materials between layers of drums or when stacked in an offset drum on drum pattern known as “pyramid” stacking.

In certain drum versions, a generally circular top face 80 of the upper drum body portion 20 is recessed below the top edge portion 90 of the chime 60 at the perimeter and surrounding the two openings 50, but in many embodiments extends above a plane defined by the top edge portion of the chime in a central area 100 approximately one times the thickness of the part in the extended area. Similarly, a generally circular bottom face 110 of the lower drum body portion 30 is recessed from the bottom edge portion 120 of the chime 70 at the perimeter, but in many embodiments extends below a plane defined by the bottom edge portion 120 of the chime 70 in a central area 130 approximately one times the thickness of the part in the extended area. This improves the stability of drums when resting on pallets and/or when drums stacked atop each other by distributing the load over a larger area.

FIGS. 6 and 9 show that the wall thicknesses of the chimes 60, 70 are approximately twice that of the sidewalls of the upper drum body portion 20 descending from the chime 60 and the lower drum body portion 30 ascending from the chime 70, respectively. The drum sidewalls extend or flare outwardly in a parabolic manner or semi-parabolic manner as they extend from the respective chime. This facilitates removal thereof from the injection molding machine.

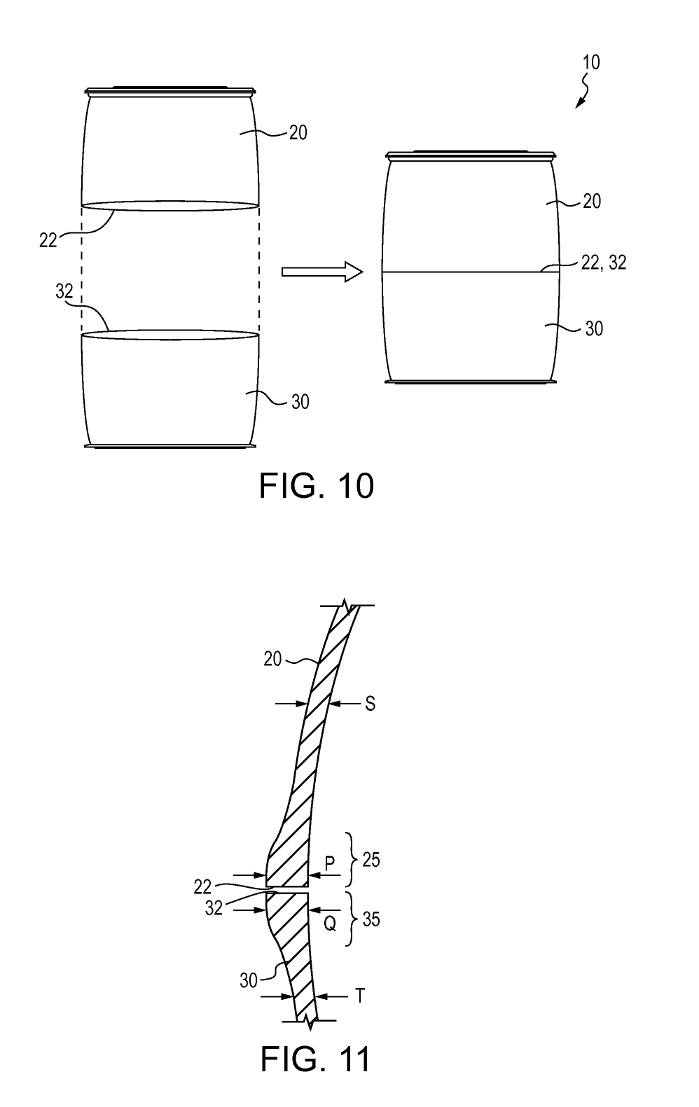

As generally illustrated in FIG. 10, the upper drum body portion 20 is aligned with the lower drum body portion 30 such that their open ends 22 and 32, respectively, are brought together to define a container or drum 10 having a generally closed volume (closed but for the opening or openings that may be formed in the top of the upper drum body portion). Typically, this includes contacting the open ends 22 and 32 and sealingly joining the ends 22, 32 together. The upper and lower drum body portions are thus joined at a central seam to form a plastic drum 10 according to the present subject matter.

In many embodiments, to facilitate joining of the upper drum body portion 20 to the lower drum body portion 30, the sidewall of the upper drum body portion 20 terminates at the open end 22 in an upper drum body welding platform 25, which is characterized by a thickening of the upper drum body portion sidewall such as schematically illustrated in FIG. 11. Similarly, the sidewall of the lower drum body 30 also terminates at the open end 32 in a lower drum body welding platform 35, which is characterized by a thickening of the lower drum body portion sidewall. This allows for a greater window of alignment when bringing the parts together for joining.

Although not wishing to be limited to any particular thicknesses or dimensions, the present subject matter provides certain upper and lower welding platform configurations as follows. In particular embodiments, the upper welding platform 25 has an increased thickness shown in FIG. 11 as thickness P which is from about 1.5 to 3 times the average thickness S of the sidewall of the remaining region of the upper drum platform 20. The term “remaining region” refers to the region of the sidewall extending between the welding platform and the chime or end face of the drum. Similarly, the lower welding platform 35 has an increased thickness shown as thickness Q which is from about 1.5 to 3 times the average thickness T of the remaining region of the sidewall of the lower drum platform 30. In particular embodiments, the thickness of the platforms 25 and 35, i.e.; thicknesses P and Q, are about 2 times the average thickness of the sidewalls, i.e., thicknesses S and T. In many embodiments, the height of a welding platform or thickened sidewall region, is about 0.5% to about 1.0%, and in certain embodiments about 2% of the total height of the drum 10.

The upper drum body portion 20 can join to the lower drum body portion 30 at the interface 22, 32 by welding (e.g., hot plate welding, infrared welding, sonic welding, spin welding etc.) or through the use of adhesives. Preferably, when a welding technique is used, the method further comprises removing a weld bead by one or more of trimming, grinding, heat processing and flame processing such that an external surface of the plastic drum at the interface is smooth. There is no protruding projection or flange as in in many joined or welded structures formed from multiple polymer sections.

As previously noted, both of the upper drum body portion and the lower drum body portion are formed by injection-molding. In many embodiments, the primary material of construction is High Molecular Weight High Density Polyethylene (HMW-HDPE) of a blow molding grade, which is generally referred to in commerce as Drum Grade resin. This material is generally not used, nor intended for use, in injection-molding processes. In many embodiments of the present subject matter, this material used. It will be appreciated that the HMW-HDPE material can be combined with other materials (including but not limited to, other thermoplastics, fillers, colorants, additives, strengthening agents and the like), either through blending or co-injection. Other injection molding resin an also be used, if desired. Nonlimiting examples include polyolefins such as polypropylene and blends of polyolefins. In a particular embodiment, the drum is composed primarily of high molecular weight high density polyethylene. Other components such as additional resins and/or additives can be included.

In a particular embodiment, the plastic drum has a capacity within the range of from about 15 to about 80 gallons. A convenient drum capacity is 55±10 gallons. Such a drum can conveniently have an overall height of about 36.2 inches, a diameter of about 23 inches (measured at the chimes and at the central joining seam), a nominal wall thickness of about 0.135 inches, and a welding platform of about 1 inch in height on both the upper and lower portions.

As noted above, most plastic drums available in the market are generally formed using blow molding processes. The injection molding/welding process of the present subject matter provides greater control of material distribution throughout the container. This in turn allows for equal or better container performance on several test measures when compared to blow molded drums, even at lower weights of construction. Test measures can include top loading (static or dynamic loading, ambient or elevated temperatures), drop impact performance, hydrostatic performance and Environmental Stress Crack Resistance (ESCR). Closure openings exhibit more precise tolerances and less ovality than found in blow molded drums. Drums are more consistent with tighter tolerances in height and diameter dimensions, and tare weights are ore consistent compared to blow molded drums. Chime formation top and bottom is smoother, more consistent, and more level than blow molded drums.

Furthermore, the interior of the drum according to the subject matter is significantly smoother than typically found on blow molded drums, leading to greater ESCR. Because there is no blowing air in the injection molding process, there is no exposure to external particulates, allowing for a cleaner drum interior. Furthermore, because there is no internal cooling water spray, as in tube extrusion, there is no exposure to water or water-borne contaminants.

Also as noted above, blow molded drums require a flash trimming process after molding. This process can be automated or manual, but in either instance leaves an uneven or ragged edge at the trimming seam. The injection molding process eliminates the flashing process, and the associated need for trimming.

The present subject matter also provides advantages over the plastic drums presently marketed under the NexDRUM® brand. Because the sidewalls of the drum are integrally formed with the top and bottom, respectively, of the upper drum body portion and the lower drum body portion, there is no central tubular extrusion utilized in the manufacture of the drum. This means that no extrusion line (e.g., an extruder, forming die, vacuum bath, haul-off, tube cutter and water system) is required. Furthermore, only one joint (e.g., weld) is formed, reducing the joining time by half as compared to the prior generation drum.

Furthermore, the use of 100% injection molded components it proves control over body gauge by up to ten times (e.g., typical 0.002 to 0.003 inch variance in body gauge for parts formed according to the subject matter versus typical 0.020 to 0.030 inch variance in extrusion molded tubular sidewalls and typical 0.040 to 0.060 inch variation for blow-molded sidewalls). This results in better performance, even at lower part weights. In addition, the elimination of a tubular extrusion allows for the production of tapered body designs. This allows for the production of a true ISO diameter while maintaining volume capacity requirements.

Furthermore, the elimination of the extruded tubular sidewall improves the joint or seam. During production of tubular extrusions, there is a concern about tube end flare concerns (body in/out), which could cause alignment issues. There are no cut ends to join to injection molded parts (thus eliminating concerns of tube cutting quality). The integration of the sidewalls from the chimes allows for the fabrication of open head chimes. In addition, the drums can be fabricated entirely within a clean room.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A method for manufacturing a plastic drum comprising:
injection-molding an upper drum body portion comprising a sidewall that terminates at an open end in an upper drum body welding platform, which is characterized by a thickening of the upper drum body portion sidewall;
injection-molding a lower drum body portion comprising a sidewall that terminates at an open end in a lower drum body welding platform, which is characterized by a thickening of the lower drum body portion sidewall;
aligning the upper drum body portion with respect to the lower drum body portion such that the upper drum body welding platform is aligned with the lower drum body welding platform at an interface; and
joining the upper drum body portion to the lower drum body portion at the interface to form the plastic drum.

2. The method according to claim 1, wherein the plastic drum is made primarily of high molecular weight high density polyethylene.

3. The method according to claim 1, wherein the upper drum body portion comprises a non-removable head.

4. The method according to claim 1, wherein the upper drum body portion comprises an open head.

5. The method according to claim 1, wherein the upper drum body portion is joined to the lower drum body portion at the interface by welding.

6. The method according to claim 5, further comprising removing a weld bead by one or more of trimming, grinding, heat processing and flame processing such that an external surface of the plastic drum at the interface is smooth.

7. The method according to claim 1, wherein the upper drum body portion is joined to the lower drum body portion at the interface by hot plate welding, infrared welding, sonic welding, spin welding or through the use of adhesives.

8. The method according to claim 1, wherein the upper drum body portion comprises a chime, which extends outwardly beyond the upper drum body portion sidewall opposite the open end.

9. The method according to claim 1, wherein the lower drum body portion comprises a chime, which extends outwardly beyond the lower drum body portion sidewall opposite the open end.

10. The method according to claim 1, wherein the upper drum body portion sidewall has a semi-parabolic shape.

11. The method according to claim 1, wherein the lower drum body portion sidewall has a semi-parabolic shape.

12. The method according to claim 3, wherein the upper drum body portion comprises a chime, which extends outwardly beyond the upper drum body portion side all opposite the open end, and wherein at least part of the non-removable head of the drum extends above the chime and forms a flat surface that extends above a plane defined by the top edge portion of the chime in an extended central area approximately one times the thickness of the part in the extended central area.

13. The method according to claim 9, wherein at least part of a bottom portion of the drum extends below the chime and forms a flat surface that extends below a plane defined by the bottom edge portion of the chime in a central extended area approximately one times the thickness of the part in the central extended area.

14. The method according to claim 1, wherein the plastic drum has a capacity within the range of from about 15 to about 80 gallons.

15. A plastic drum made by the method of claim 1.

16. The plastic drum according to claim 15, wherein the plastic drum is made primarily of high molecular weight high density polyethylene.

17. The plastic drum according to claim 15, wherein the upper drum body portion comprises a non-removable head.

18. The plastic drum according to claim 15, wherein the upper drum body portion comprises an open head.

19. The plastic drum according to claim 15, wherein the upper drum body portion is joined to the rawer drum body portion at the interface by welding.

20. The plastic drum according to claim 19, wherein an external surface of the plastic drum at the interface is smooth.

21. A plastic drum comprising:
an upper drum body portion including a circular top face defining an outer periphery, a continuous first sidewall extending from the outer periphery of the top face to thereby define a first open end, the first sidewall having a region of increased thickness adjacent the first open end;
a lower drum body portion including a circular bottom face defining an outer periphery, a continuous second sidewall extending from the outer periphery of the bottom face to thereby define a second open end, the second sidewall having a region of increased thickness adjacent the second open end;
wherein the first open end contacts and sealingly engages the second open end along a single central joining seam.

22. The plastic drum of claim 21 wherein the region of increased thickness of the sidewall of the upper drum body portion is from 1.5 to 3 times the average thickness of remaining regions of the sidewall of the upper drum body portion.

23. The plastic drum of claim 21 wherein the region of increased thickness of the sidewall of the lower drum body portion is from 1.5 to 3 times the average thickness of remaining regions of the sidewall of the lower drum body portion

24. The plastic drum of claim 21 wherein both the upper drum body portion and the lower drum body portion include high molecular weight high density polyethylene.
